(19) United States
(12) Patent Application Publication
(10) Pub. No.: US 2019/0049762 A1
(43) Pub. Date: Feb. 14, 2019

(54) PLANAR LIGHT SOURCE, BACKLIGHT UNIT, AND LIQUID CRYSTAL DISPLAY DEVICE

(71) Applicant: FUJIFILM Corporation, Tokyo (JP)

(72) Inventors: Takashi YONEMOTO, Kanagawa (JP); Hirofumi TOYAMA, Kanagawa (JP); Tatsuya OBA, Kanagawa (JP)

(73) Assignee: FUJIFILM Corporation, Tokyo (JP)

(21) Appl. No.: 16/152,801

(22) Filed: Oct. 5, 2018

Related U.S. Application Data
(63) Continuation of application No. PCT/JP2017/014506, filed on Apr. 7, 2017.

(30) Foreign Application Priority Data
Apr. 8, 2016 (JP) 2016-078275
Jul. 13, 2016 (JP) 2016-138635

(51) Int. Cl. G02F 1/13357; G02F 1/1335

(52) U.S. Cl. CPC G02F 1/1336; G02F 1/133605; G02F 2001/133614; G02F 1/133603; G02F 2001/133628; G02F 1/133611

(57) ABSTRACT

A thin planar light source, a backlight unit using the same, and a liquid crystal display device using the backlight unit includes: a heat radiation element; a reflective element; an excitation light source; a brightness conversion element; and a wavelength homogenizing element, wherein the excitation light source has a light emitting surface between the reflective element and an emission surface of the planar light source, emits a light having a first wavelength, the wavelength conversion element is positioned between the reflective element and the brightness homogenizing element, is thermally coupled to a heat radiation element, absorbs the light having a first wavelength, and emits light having a wavelength different from the light having a first wavelength, and reflectance of the brightness homogenizing element with respect to light on the excitation light source side has distribution in an in-plane.

### CROSS-REFERENCE TO RELATED APPLICATIONS

This application is a Continuation of PCT International Application No. PCT/JP2017/014506 filed on Apr. 7, 2017, which claims priority under 35 U.S.C. § 119(a) to Japanese Patent Application No. 2016-078275, filed on Apr. 8, 2016 and Japanese Patent Application No. 2016-138635, filed on Jul. 13, 2017. Each of the above applications is hereby expressly incorporated by reference, in its entirety, into the present application.

### BACKGROUND OF THE INVENTION

### 1. Field of the Invention

The present invention relates to a planar light source, a backlight unit including the same, and a liquid crystal display device.

### 2. Description of the Related Art

A liquid crystal display device (hereinafter, referred to as an LCD) expands applications thereof as an image display device that has low power consumption and saves spaces. In the recent liquid crystal display device, as the performance improvement, a higher dynamic range, further power saving, the improvement in color reproducibility, and the like are required. Particularly, in view of compatibility between a high dynamic range and power saving, a backlight form referred to as a so-called direct type is preferably used.

As means for improving the color reproducibility; a backlight having a wavelength conversion element using quantum dots is known. Quantum dots are materials that exhibit a quantum confinement effect as nano-sized semiconductor materials. Because quantum dots emit light in a narrower wavelength band than general phosphors, in a case of being used as a wavelength conversion element, the color purity of the light of the backlight can be improved.

On the other hand, quantum dots are expensive wavelength conversion materials, and in a case of being arranged in the same manner as a prism sheet or a diffusion film so as to cover the entire surface of the backlight as a wavelength conversion element, the cost for manufacturing the backlight and the liquid crystal display device increases. For example, as a configuration that provides a uniform light source in a high dynamic range while reducing the amount of using quantum dot materials, JP2015-149469A and JP2015-156464A disclose configurations of arranging wavelength conversion elements only in a partial region of an in-plane.

### SUMMARY OF THE INVENTION

However, according to studies made by the inventors, in a liquid crystal display device using a planar light source in which wavelength conversion elements including quantum dots are arranged in a part of an in-plane, it has been found that the quality deterioration of a display image due to uneven distribution of the temperature of the panel is caused.

The inventors assume that this phenomenon is as follows. That is, in a case of absorbing the excitation light and emitting light, the wavelength conversion element emits an amount of the energy loss due to at least the quantum efficiency and an amount of the energy loss by converting the excitation light having a short wavelength into emission of the long wavelength, as heat. In order to realize a white light source having the same brightness as a backlight using a large-area wavelength conversion element well-known in the related art, a planar light source having a wavelength conversion element locally in a local region of an in-plane is required to locally absorb a lot of excitation light and emit light. That is, the heat generation of the wavelength conversion element concentrates on the local region of the in-plane. As a result, temperature unevenness occurs in the in-plane of the planar light source.

According to the recent tendency to thin the display, a backlight and a liquid crystal panel are installed such that a distance therebetween is very narrow, and thus the in-plane temperature of the planar light source becomes remarkably uneven. The reflection of this temperature difference to the liquid crystal panel causes a change in the optical characteristics of respective members of the panel, and thus the change causes tint unevenness in the in-plane and light leak during black display.

It is possible to suppress heat conduction and suppress light leak by providing a distance in the planar light source or between the planar light source and the panel, but providing the distance is contradictory to the tendency to thin a liquid crystal display device.

The present invention is achieved by the following configurations.

(I) A planar light source comprising: a heat radiation element; a reflective element; at least one excitation light source; at least one wavelength conversion element; and a brightness homogenizing element, in which the at least one excitation light source has a light emitting surface between the reflective element and an emission surface of the planar light source and emits at least light having a first wavelength, the wavelength conversion element is positioned between the reflective element and the brightness homogenizing element, is thermally coupled to a heat radiation element, absorbs at least a part of a light having a first wavelength, and emits at least one light having a wavelength different from the light having a first wavelength, and reflectance of the brightness homogenizing element with respect to light on the excitation light source side has distribution in an in-plane.

(2) The planar light source according to (1), in which the wavelength conversion element includes a quantum dot.

(3) The planar light source according to (1) or (2), in which reflectance of the brightness homogenizing element with respect to light on the excitation light source side is maximum on an optical axis of the excitation light source.

(4) The planar light source according to any one of (1) to (3), in which the wavelength conversion element is in contact with the reflective element or is bonded to the reflective element with an adhesive or a pressure sensitive adhesive.

(5) A backlight for a liquid crystal display device using the planar light source according to any one of (1) to (4).

(6) A liquid crystal display device having the backlight according to (5).

According to the present invention, it is possible to provide a thin planar light source having a wavelength conversion element which is used for a backlight of a liquid crystal display device and in which uneven rise of the in-plane temperature is suppressed in the planar light source and it is possible to provide an excellent liquid crystal display device without unevenness of a tint due to uneven distribution of panel temperature or light leak during black display.

### BRIEF DESCRIPTION OF THE DRAWINGS

FIG. 1 illustrates an example of a planar light source according to an aspect of the present invention.

FIG. 2 illustrates another example of the planar light source according to the aspect of the present invention.

FIG. 3A illustrates still another example of the planaright source according to the aspect of the present invention,

FIG. 3B illustrates a partial enlarged view of FIG. 3A.

FIG. 4 illustrates an example of an arrangement of a wavelength conversion element in the planar light source according to the aspect of the present invention.

FIG. 5 illustrates an example of the wavelength conversion element according to the aspect of the present invention.

FIG. 6 illustrates another example of the wavelength conversion element according to the aspect of the present invention.

FIG. 7 illustrates another example of the arrangement of the wavelength conversion element in the planar light source according to the aspect of the present invention.

### DESCRIPTION OF TILE PREFERRED EMBODIMENTS

Hereinafter, the lighting device, the backlight unit, and the liquid crystal display device of the embodiment of the present invention are specifically described based on a suitable example illustrated in the accompanying drawings.

The following description of constituent elements may be made based on a representative embodiment of the present invention, but the present invention is not limited to the embodiment.

According to the present specification, the numerical range expressed by using “to” means a range including numerical values described before and after “to” as a lower limit value and an upper limit value.

In the present specification, the expression “(meth)acrylate” means any one or both of acrylate and methacrylate. The same is applied to “(meth)acryloyl” and the like.

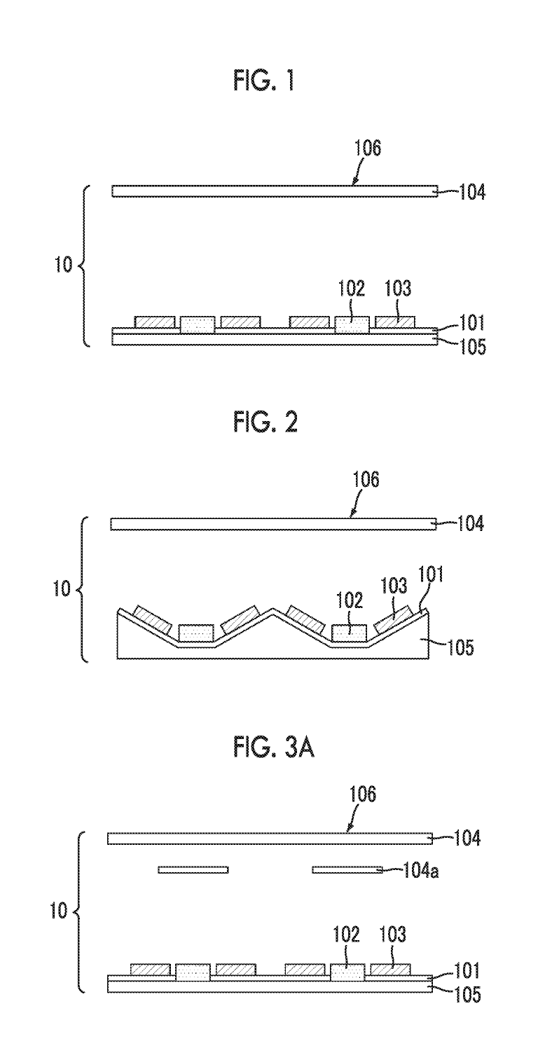

An example of a planar light source of the embodiment of the present invention is conceptually illustrated in FIG. 1.

A planar light source 10 is a direct-light type light source in which excitation light sources are arranged in the in-plane in parallel and basically includes a heat radiation element 105, a reflective element 101, an excitation light source 102, a wavelength conversion element 103, and a brightness homogenizing element 104.

FIG. 1 is merely a schematic view, and the planar light source 10 may include various known members provided in known planar light sources such as an LCD backlight, for example, an LED substrate, wiring, and a housing, in addition to the members shown in the drawing.

(Heat Radiation Element)

According to an aspect, the heat radiation element 105 has a plate-like structure spreading over the entire rear surface of the planar light source. The heat radiation element may function as a substrate for supporting the planar light source 10. In this case, in order to install the excitation light source 102 and the wavelength conversion element 103, the surface may be processed into any shape such as unevenness.

In another embodiment, the light guide plate may be arranged in a stripe pattern in a lateral direction or a machine direction of the planar light source.

In still another embodiment, the brightness homogenizing element may have a heat radiation performance.

FIG. 2 conceptually illustrates an example of the planar light source in which the heat radiation element 105 has unevenness. In the example illustrated in FIG. 2, the heat radiation element 105 is obtained by processing the upper surface of a flat sheet-shaped plate material into an uneven shape, but the present invention is not limited thereto and may have a configuration of causing the heat radiation element to have an uneven shape by bending the plate material.

It is preferable to use a member having a high thermal diffusion performance as the heat radiation element 105.

In order to improve the thermal diffusion performance, it is preferable that the heat conduction efficiency of the member used for the heat radiation element 105 is high. The heat conduction efficiency is determined by the thermal conductivity of the material to be used and the cross sectional area of the heat flow path, and the heat conduction efficiency can be increased by using a material having high thermal conductivity or increasing the heat flow path, that is, increasing the width of the thickness of the member. For example, it is preferable as the sheet thickness is greater, but in a case where the sheet thickness is great, the weight becomes heavy. Therefore, an aluminum material having a sheet thickness of about 1 mm and a high thermal conductivity can be used in the manufacturing. In the present invention, the material of the heat radiation element 105 is not particularly limited to aluminum, but different kinds of metal materials can be used. For example, a material such as copper having a thermal conductivity higher than that of the aluminum material can be used. A composite material obtained by combining alloys, metal, or a material having a high thermal conductivity with a resin or a material obtained by burying a metal wire or the like in a resin so as to provide an efficient heat flow path may be used.

(Thermal Coupling)

The heat radiation element 105 is thermally coupled to the wavelength conversion element 103 described below.

Here, the thermal coupling refers to a state in which the wavelength conversion element 103 and the heat radiation element 105 are in contact with each other directly or with an intervening layer having a small thermal resistance interposed therebetween, and the thermal energy included in the wavelength conversion element 103 promptly moves to the heat radiation element 105.

As the intervening layer having a small thermal resistance, an adhesive or a pressure sensitive adhesive may be used. It is particularly preferable to use a so-called thermally conductive adhesive in which a material with high thermal conductivity is compounded so as to enhance thermal conductivity.

A case where the wavelength conversion element 103 is bonded with an adhesive or a pressure sensitive adhesive via the reflective element 101 is included in a thermally coupled state.

In a case where the wavelength conversion element 103 and the heat radiation element 105 are thermally coupled, the heat generated by the wavelength conversion element 103 is radiated, the in-plane temperature of the planar light source is homogenized, such that light leak caused by the temperature difference can be reduced.

It is preferable that the wavelength conversion element 103 and the heat radiation element 105 are in surface contact with each other directly or with an intervening layer interposed therebetween. The surface contact is preferably 30% or more, more preferably 50% or more, and even more preferably 70% or more with respect to the area of the wavelength conversion element 103. A larger heat radiation effect can be obtained by increasing the contact area.

(Reflective Element)

The planar light source 10 according to the embodiment of the present invention includes the reflective element 101.

The reflective element 101 is a plate-like or film-like member provided so as to face an emission surface 106.

For example, the reflective element 101 has a function such as reflection, diffusion, and scattering, and accordingly it is possible to increase the front brightness by effectively using light from the excitation light source.

The reflective element 101 is not particularly limited, a well-known element can be used as disclosed in JP3416302B, JP3363565B, JP4091978B, and JP3448626B, and the contents of the documents are incorporated into the present specification.

As an example of the reflective element 101, a white PET is suitably used.

According to the aspect, white PET having a thickness of 100 μm and a reflectance of 98% or more is used as the reflective element 101, holes are made such that the light emitting surface is disposed between the reflective element 101 and the emission surface 106 of the planar light source 10, and the entire bottom surface of the housing can be covered.

(Rightness Homogenizing Element)

The brightness homogenizing element 104 has a function of leveling excitation light from the plurality of excitation light sources 102 and emitted light from the wavelength conversion element 103 in the in-plane. According to this action, bright lines/dark lines which can be generated due to interference or refraction of light inside the backlight or unevenness of light quantity distribution due to the distribution of the excitation light source 102 is removed, so as to realize the backlight having a desirable light quantity distribution.

At the same time, the brightness homogenizing element 104 also has the function of selectively reflecting or scattering a part of the excitation light emitted by the excitation light source 102 backward, so as to change the traveling direction of the light and cause the light to be absorbed by the wavelength conversion element 103.

The above function is specifically described.

A part of the excitation light from the excitation light source 102 penetrates the brightness homogenizing element 104 and the other light is reflected or scattered backward. In order to realize white as a plane light source, it is required that the wavelength conversion element 103 absorbs more excitation light and emits more fluorescence. For that purpose, it is necessary to cause more excitation light to be reflected at the brightness homogenizing element 104 or to be scattered backward, such that the traveling direction of the light is changed and the light is caused to be absorbed by the wavelength conversion element 103. Accordingly, it is preferable to increase the reflectance in the region in which the excitation light intensity is high by providing the reflectance distribution in the in-plane of the brightness homogenizing element 104.

A difference between the maximum value and the minimum value of the in-plane reflectance of the brightness homogenizing element is preferably 1% or more, more preferably 10% or more, even more preferably 20% or more, and still even more preferably 30% or more. The reflectance can be measured by the method described later.

The maximum value of the reflectance of the in-plane of the brightness homogenizing element 104 is preferably 50% or more, more preferably 70% or more, and even more preferably 90% or more.

It is preferable that the reflectance of the brightness homogenizing element 104 with respect to the light on the excitation light source side is periodic in the in-plane. It is even more preferable to have the same period as in the arrangement of the excitation ight source 102.

Generally, the excitation light from the excitation light source 102 has the maximum intensity on its optical axis. Accordingly, it is preferable that the reflectance of the brightness homogenizing element 104 with respect to the light on the excitation light source side is maximum on the optical axis of the excitation light source 102. In a case where the reflectance is maximum on the optical axis, the more excitation light from the excitation light source 102 is reflected at the brightness homogenizing element 104 or scattered backward and is absorbed by the wavelength conversion element 103. That is, it is possible to reduce the amount of the phosphor included in the wavelength conversion element 103.

The brightness homogenizing element 104 may have any one or more of wavelength selectivity, polarization selectivity, incident angle selectivity.

The brightness homogenizing element 104 may be one optical sheet or a laminate including a plurality of optical sheets.

Examples of the optical sheet forming the brightness homogenizing element 104 include a diffusion sheet, a prism sheet, and a brightness improving sheet having polarization selectivity. As another example, as disclosed in JP2015-156464A, a light diffusing member that covers a plurality of light sources in common and a light diffusing member that similarly covers a part of the in-plane can be exemplified, but the present invention is not limited thereto.

According to an aspect, the brightness homogenizing element is a lamination layer of a light diffusion member, a diffusion plate, two prism sheets, and DBEF which covers a plurality of light sources in common disclosed in JP2015-156464A. The distance between the reflective element and the light diffusion member is 1 mm to 8 mm, more preferably 3 mm to 6 mm, and the distance between the light diffusion member and the diffusion plate is 1 to 3 ram and more preferably 1.5 to 2.5 mm. Although the diffusion plate, the two prism sheets, and the DBEF are directly laminated, each distance can be randomly set, and the present invention is not limited thereto.

As the distance between the reflective element 101 and the brightness homogenizing element 104 is reduced, it is possible to provide the liquid crystal display device satisfying the requirement of thinning.

(Method of Measuring Reflectance)

The reflectance of the brightness homogenizing element 104 can be measured by the following method.

On the black paper, the brightness homogenizing element 104 is arranged such that the excitation light source side becomes the upper side, measurement is performed by using a spectrophotometer (CM-2022, manufactured by Konica Minolta, Inc.) from the excitation light source side, and a value of the reflectance with respect to the light of 450 nm is read.

The in-plane of the brightness homogenizing element 104 is repeatedly measured at an interval of 2 mm, and the maximum value and the minimum value thereof are used as evaluation values.

A part of the brightness homogenizing element 104 may be spaced.

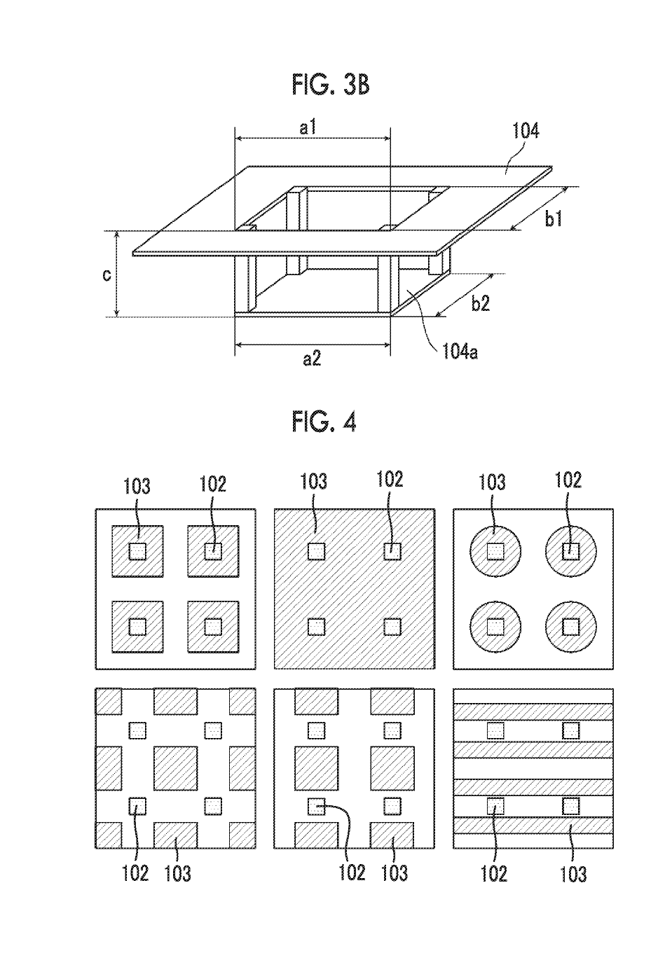

FIG. 3A conceptually illustrates an example of an example of the planar light source 10 in which a part of the brightness homogenizing element 104 is spaced, and FIG. 3B illustrates a partially enlarged view of the brightness homogenizing element 104.

As illustrated in FIGS. 3A and 3B, the brightness homogenizing element 104 has a spacing portion 104a a part of which is spaced in the thickness direction.

According to an aspect, it is preferable that the spacing portion includes a region on the optical axis of the excitation light source 102.

According to an aspect, it is preferable that the spacing portion 104a of the brightness homogenizing element 104 is close to the excitation light source 102. In a case where the spacing portion comes closer to the light source, the excitation light from the excitation light source 102 is reflected or scattered backward, and it is possible to reduce the size of the spacing portion 104a required for obtaining white light by causing more excitation light to be absorbed by the wavelength conversion element 103. Therefore, in a case where the reflectance of the spacing portion 104a is increased, it is possible to reduce the influence of shadows visually recognized on the planar light source. In this manner, it is possible to provide a planar light source having more even brightness and tint in a planar light source in which a wavelength conversion element is locally arranged in a partial region in the in-plane, and it is possible to provide an excellent liquid crystal display device.

The distance between the spacing portion 104a of the brightness homogenizing element 104 and the excitation light source 102 is preferably 0.1 mm to 10 mm, more preferably 0.5 mm to 6 mm, even more preferably 1 mm to 4 mm, and particularly preferably 2 mm to 4 mm.

A distance c between the main surface of the brightness homogenizing element 104 and the spacing portion 104a in the thickness direction is preferably 0.1 mm to 3 mm, more preferably 0.5 mm to 2 mm, and particularly preferably 0.8 mm to 1.5 mm.

By providing a suitable distance, it is possible to reduce the influence of the shadow visually recognized on the planar light source in a case where the white light wraps around and the reflectance of the spacing portion 104a is increased.

As illustrated in FIG. 3B, in the case of a structure in which a part of the brightness homogenizing element 104 is spaced, in order to maintain the structure of the spacing portion 104a, a brightness homogenizing layer and the spacing portion 104a may be physically integrated or connected to each other.

The spacing portion 104a may also be filled with an optically transparent medium.

The shape of the spacing portion 104a is not particularly limited, but is preferably a rectangle or a circle.

In a case where the spacing portion 104a is a rectangle, a length a2 and a length b2 of sides thereof are preferably 5 mm to 30 mm, more preferably 5 ram to 20 mm, and even more preferably 7 mm to 15 mm.

The reflectance of the spacing portion 104a of the brightness homogenizing element 104 is preferably 90% or more, more preferably 95% or more, and particularly preferably 99% or more. By increasing the reflectance, more excitation light can be reflected or scattered backward such that more excitation light can be absorbed by the wavelength conversion element 103, and thus it is possible to obtain white light by using a small amount of phosphors.

In the configuration having the spacing portion 104a, it is preferable that the reflectance of a region corresponding to the spacing portion 104a of the brightness homogenizing element 104 is lower than that of the other regions.

The reflectance of the region corresponding to the spacing portion 104a is preferably 60% or less, more preferably 50% or less, and even more preferably 40% or less.

It is possible to reduce the influence of shadows visually recognized on the planar light source in a case where the reflectance of the spacing portion 104a is increased.

The brightness homogenizing element 104 may also function as a heat radiation element.

According to one aspect, it is also possible to use an element obtained by bonding white PET on the surface of a plate of an aluminum material with holes.

According to one embodiment, the distance between the brightness homogenizing element 104 and the reflective element 101 is 5 mm, but the present invention is not limited thereto.

As the distance is reduced, it is possible to provide a liquid crystal display device that satisfies the requirement for thinning.

(Wavelength Conversion Element)

The wavelength conversion element 103 is a well-known wavelength conversion material that absorbs at least a part of the light having a first wavelength emitted by the excitation light source and emits at least one light having a wavelength different from that of the light having a first wavelength.

The wavelength conversion element 103 may have a sheet shape and may have a cell shape sealed with glass or the like.

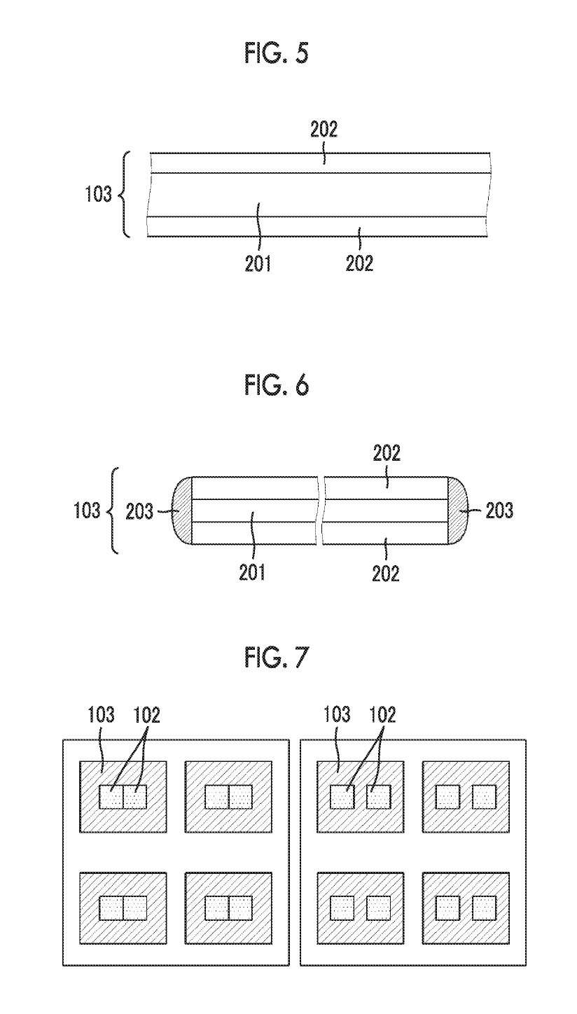

FIG. 5 conceptually illustrates a typical configuration of a sheet-like wavelength conversion element 103. The wavelength conversion element 103 can have a wavelength conversion layer 201 and a supporting film 202 that sandwiches and supports the wavelength conversion layer 201.

For example, the wavelength conversion element 103 is a fluorescent layer obtained by dispersing a large number of phosphors in a matrix of a curable resin or the like and has a function of converting the wavelength of light incident on the wavelength conversion element 103 and emitting the light.

For example, in a case where the blue light applied from the excitation light source 102 is incident on the wavelength conversion element 103, the wavelength conversion element 103 converts the wavelength of at least a part of the blue light so as to be red light or green light by the effect of the phosphor contained inside and emits the light.

Here, the blue light is light having a light emission center wavelength in a wavelength range of 430 to 500 nm, the green light is light having a light emission center wavelength in a wavelength range of more than 500 nm and 600 nm or less, and the red light is light having a light emission center wavelength in a wavelength range of more than 600 nm and 680 nm or less.

The function of the wavelength conversion exhibited by the fluorescent layer is not limited to the configuration in which the wavelength of the blue light is converted to be the red light or the green light, and may be a configuration in which at least a part of the incidence rays is converted into light having a different wavelength.

The phosphor is excited by at least incident excitation light and emits fluorescence.

The types of kind of the phosphor contained in the fluorescent layer are not particularly limited, and various well-known phosphors may be suitably selected according to the performance of the required wavelength conversion or the like.

Examples of such phosphors include a phosphor obtained by doping a rare earth ion to phosphoric acid salt, aluminic acid salt, metal oxides, and the like, a phosphor obtained by doping an activating ion to a semiconducting material such as metal sulfide, metal nitride, and the like, and a phosphor using a quantum confinement effect known as quantum dots, and the like, in addition to an organic fluorescent dye and an organic fluorescent pigment. Among these, quantum dots which can realize a light source having a narrow emission spectrum width and excellent color reproducibility in a case of being used for a display and which has excellent light emission quantum efficiency are suitably used in the present invention.

That is, according to the present invention, a quantum dot layer obtained by dispersing a quantum dot in a matrix of a resin or the like is suitably used as the wavelength conversion element 103. In the wavelength conversion element, as a preferable aspect, a quantum dot layer is provided.

With respect to the quantum dot, for example, paragraphs 0060 to 0066 of JP2012-169271A may be referred to, but the present invention is not limited to these. As the quantum dot, commercially available products can be used without any limitation. The emission wavelength of the quantum dot may be generally adjusted by the composition and the size of the particle.

It is preferable that the quantum dot is uniformly dispersed in the matrix, but the quantum dot may be dispersed with bias in the matrix. The quantum dot may be used singly or two or more kinds thereof may be used in combination.

In a case where two or more quantum dots are used together, two or more kinds of quantum dots having different wavelengths of the emitted light may be used.

Specifically; examples of the well-known quantum dots include a quantum dot (A) having a light emission center wavelength in a wavelength range of more than 600 nm and 680 nm or less, a quantum dot (B) having a light emission center wavelength in a wavelength range of more than 0.500 nm and 600 nm or less, and a quantum dot (C) having a light emission center wavelength in a wavelength range of 400 nm to 500 nm. The quantum dot (A) emits red light excited by excitation light, the quantum dot (B) emits green light excited by excitation light, and the quantum dot (C) emits blue light excited by excitation light.

For example, in a case where the blue light is caused to be incident to the quantum dot layer including the quantum dot (A) and the quantum dot (B) as the excitation light, white light may be realized by the red light emitted by the quantum dot (A), the green light emitted by the quantum dot (B), and the blue light passing through the quantum dot layer. Otherwise, in a case where the ultraviolet light is caused to be incident to the quantum dot layer including the quantum dots (A), (B), and (C), as the excitation light, white light may be realized by the red light emitted by the quantum dot (A), the green light emitted by the quantum dot (B), and the blue light emitted by the quantum dot (C).

As the quantum dot, a tetrapod-type quantum dot or a so-called quantum rod which has a rod shape and directivity and emits polarized light may be used.

As described above, in the wavelength conversion element, the wavelength conversion layer 201 is formed by dispersing a quantum dot or the like as a matrix of a resin or the like.

Here, as the matrix, well-known matrices used in the quantum dot layer can be used. Suitable matrix materials include epoxy, acrylate, norbornene, polyethylene, poly(vinyl butyral):poly(vinyl acetate), polyurea, and polyurethane; silicone and silicone derivatives including but not limited to aminosilicone (AMS), polyphenylmethylsiloxane, polyphenylalkylsiloxane, polydiphenylsiloxane, polydialkylsiloxane, silsesquioxane, silicone fluoride, and vinyl and hydride substituted silicones; an acrylic polymer and copolymer formed from monomers and including but not limited to methyl methacrylate, butyl methacrylate, and lauryl methacrylate; a styrene-based polymer such as polystyrene, aminopolystyrene (APS) and poly(acrylonitrile ethylene styrene) (AES); a polymer crosslinked with a bifunctional monomer such as divinylbenzene; a crosslinking agent suitable for crosslinking with the ligand material, and epoxide which combine with ligand amine (for example, APS or PEI ligand amine) to form epoxy; but the matrix material is not limited thereto.

As a matrix of the wavelength conversion element 103, a polymerizable composition (coating composition) including two or more kinds of polymerizable compounds may be cured.

The matrix for forming the wavelength conversion element 103, in other words, the polymerizable composition that becomes the wavelength conversion element 103, may include necessary components such as a viscosity regulator and a solvent, if necessary. The polymerizable composition that becomes the wavelength conversion element 103 is, in other words, a polymerizable composition for forming the wavelength conversion element 103.

<Viscosity Regulator>

The polymerizable composition may include a viscosity regulator, if necessary. The viscosity regulator is preferably a filler having a particle diameter of 5 to 300 nm. The viscosity regulator is preferably a thixotropic agent for providing thixotropy properties. According to the present invention, thixotropy properties refer to properties of reducing the viscosity with increasing the shear rate in a liquid composition, and the thixotropic agent refers to a material that is included in a liquid composition and has a function of providing thixotropy properties to the composition.

Specific examples of the thixotropic agent include fumed silica, alumina, silicon nitride, titanium dioxide, calcium carbonate, zinc oxide, talc, mica, feldspar, kaolinite (kaolin clay), pyrophylite (wax rock clay), sericite (silk mica), bentonite, smectite vermiculite (montmorillonite, heidellite, non-toronite, and saponite), organic bentonite, and organic smectite.

<Solvent>

The polymerizable composition that becomes the wavelength conversion layer 201 may include a solvent, if necessary. The type and the addition amount of the solvent used in this case are not particularly limited. For example, as the solvent, the organic solvent may be used singly or two or more kinds thereof may be used in a mixture.

In the wavelength conversion element 103, an amount of the resin that becomes a matrix may be suitably determined according to the kinds of the functional materials included in the wavelength conversion element 103.

The thickness of the wavelength conversion element 103 may be also suitably determined according to types or applications of the wavelength conversion element 103.

In the illustrated example, since the wavelength conversion element 103 is a quantum dot layer, and thus in view of handling properties and light emission characteristics, the thickness of the wavelength conversion element 103 is preferably 5 to 200 μm and more preferably 10 to 150 μm.

The thickness of the wavelength conversion element 103 intends an average thickness, and the average thickness is obtained by measuring thicknesses of the quantum dot layer at 10 or more optional points and arithmetically averaging the thicknesses.

In the polymerizable composition that becomes the wavelength conversion element 103 such as a quantum dot layer, a polymerization initiator, a silane coupling agent, or the like may be added, if necessary.

As the supporting film 202, various film-like materials (sheet-like materials) that are capable of supporting the wavelength conversion layer 201 can be used.

It is preferable that the supporting film 202 is preferably a so-called gas barrier film obtained by forming a gas barrier layer through which oxygen or the like does not pass on the front surface of the supporting substrate. That is, it is preferable that the supporting film 202 covers the main surface of the wavelength conversion layer 201 and also functions as a member for suppressing the infiltration of moisture or oxygen from a main surface of the wavelength conversion layer 201.

With respect to the wavelength conversion element 103, the supporting films 202 on both main surfaces of the wavelength conversion layer 201 are preferably gas barrier films, but the present invention is not limited thereto. For example, in a case where it is less likely to infiltrate moisture or oxygen from the main surface on one side of the wavelength conversion element 103, a configuration in which the supporting film 202 only on one main surface of the wavelength conversion layer 201 is a gas barrier film may be provided. However, in order to more reliably prevent the deterioration of the wavelength conversion layer 201 due to moisture or oxygen, it is preferable that the supporting films 202 on both of the main surfaces of the wavelength conversion layer 201 are gas harrier films, as in the illustrated example.

As described above, it is preferable that the supporting film 202 is a gas barrier film. Specifically, the water vapor permeability of the supporting film 202 is preferably 1×10⁻³ g/(m²·day) or less. The oxygen permeability of the supporting film 202 is preferably 1×10⁻² cc/(m²·day·atm) or less.

In a case where the supporting film 202 having the low water vapor permeability and the low oxygen permeability, that is, having high gas barrier properties is used, it is possible to prevent the infiltration of moisture or oxygen to the wavelength conversion layer 201 and suitably prevent the deterioration of the wavelength conversion layer 201.

For example, the water vapor permeability is measured by the MOCON method under conditions of the temperature of 40° C. and a relative humidity of 90% M. In a case where the water vapor permeability is greater than the measurement limit of the MOCON method, the water vapor permeability is measured by the calcium corrosion method (method disclosed in JP2005-283561A). For example, the oxygen permeability may be measured under the conditions of the temperature of 25° C. and the humidity of 60% RH by using a measuring device (manufactured by Nippon API Co., Ltd.), according to the APIMS method (atmospheric pressure ionization mass spectrometry).

The thickness of the supporting film 202 is preferably 5 to 100 μm, more preferably 10 to 70 μm, and particularly preferably 15 to 55 μm.

It is preferable that the thickness of the supporting film 202 is 5 μm or more, since the thickness of the wavelength conversion layer 201 may be caused to be uniform in a case of forming the wavelength conversion layer 201 between two supporting films 202. It is preferable that the thickness of the supporting film 202 is caused to be 100 μm or less, since the entire thickness of the wavelength conversion element 103 including the wavelength conversion layer 201 may be caused to be thin.

As described above, as the supporting film 202, various kinds of films that are capable of supporting the wavelength conversion layer 201 or the polymerizable composition may be used, and various kinds of films having desired gas barrier properties is preferably used.

Here, the supporting film 202 is preferably transparent, and, for example, glass, a transparent inorganic crystalline material, a transparent resin material, or the like may be used. The supporting film 202 may have a rigid sheet shape or may have a flexible film shape. The supporting film 202 may have an elongate shape capable of being wound or may have a sheet-like shape that may be cut into predetermined dimensions in advance.

In a case where a gas barrier film is used as the supporting film 202, various kinds of gas barrier films may be used. For example, an organic-inorganic lamination type barrier film obtained by forming one or more sets of the combination of a supporting substrate, an inorganic layer as a gas barrier layer on a supporting substrate, and an organic layer that becomes a base substrate (formation surface) of the inorganic layer may be suitably used.

Examples thereof include a gas barrier film having one set of the combination of an inorganic layer and a base substrate organic layer, which has an organic layer on one front surface of the supporting substrate and has an inorganic layer on the front surface of the organic layer using an organic layer as a base substrate layer.

Examples thereof include a gas barrier film having two sets of the combination of inorganic layers and a base substrate organic layers, which has an organic layer on one front surface of the supporting substrate, has an inorganic layer on the front surface of the organic layer using the organic layer as a base substrate layer, has a second organic layer on the inorganic layer, and has a second inorganic layer using the second organic layer as a base substrate layer.

Otherwise, a gas barrier film having three or more sets of inorganic layers and base substrate organic layers may be used. Basically; as more sets of the combination of inorganic layers and base substrate organic layers are provided, higher gas barrier properties may be obtained.

In the organic-inorganic lamination type barrier film, gas barrier properties are mainly exhibited in the inorganic layers. In the following descriptions, the “organic-inorganic lamination type barrier film” is also referred to as a “lamination type barrier film”.

Accordingly, in order to use a lamination type barrier film as the supporting film 202 of the wavelength conversion element 103, in all layer configurations, it is preferable that an upper most layer, that is, an outermost layer on an opposite side of the supporting substrate, is an inorganic layer, and an inorganic layer is provided on the inner side, that is, on the wavelength conversion layer 201 side. That is, in a case where the lamination type barrier film is used as the supporting film 202 of the wavelength conversion element 103, it is preferable that, as a state in which the inorganic layer comes into contact with the wavelength conversion layer 201, the wavelength conversion layer 201 is sandwiched between the supporting films 202.

Accordingly, it is possible to suitably prevent infiltration of oxygen or the like from the end face of the organic layer to the wavelength conversion layer 201.

As the supporting substrate of the lamination type barrier film, various kinds of supports used as supports in well-known gas barrier films may be used.

Among these, in view of easiness of thinning, lightweight and suitability for flexibility, or the like, a film including various kinds of plastics (polymer materials/resin materials) are suitably used.

Specifically, suitable examples thereof include resin films including polyethylene (PE), polyethylene naphthalate (PEN), polyamide (PA), polyethylene terephthalate (PET), polyvinyl chloride (PVC), polyvinyl alcohol (PVA), polyacritonitrile (PAN), polyimide (PI), transparent polyimide, polymethyimethacrylate resin (PMMA), polycarbonate (PC), polyacrylate, polymethacrylate, polypropylene (PP), polystyrene (PS), ABS, a cycloolefin copolymer (COC), a cycloolefin polymer (COP), and triacetylcellulose (TAC).

In a case where a gas harrier film may be used in the supporting film 202, these resin films may be suitably used as the supporting film 202.

The thickness of the supporting substrate may be suitably set according to the application or the size thereof. According to the research by the present inventors, the thickness of the supporting substrate is preferably about 10 to 100 μm. In a case of where the thickness of the supporting substrate is caused to be in this range, preferable results in view of lightweight or thinning may be obtained.

With respect to the supporting substrate, functions such as anti-reflection, the phase difference control, the light extraction efficiency improvement, and the like may be provided on the front surface of such a plastic film.

As described above, in the lamination type barrier film, the gas harrier layer mainly has an inorganic layer exhibiting gas barrier properties and a organic layer that becomes a base substrate layer of the inorganic layer.

In the lamination type barrier film, it is preferable that the upper most layer is an inorganic layer, and the inorganic layer side faces the wavelength conversion layer 201. However, the lamination type harrier film may have an organic layer that protects the inorganic layer on the upper most layer, if necessary.

The organic layer becomes a base substrate layer of an inorganic layer that mainly exhibits gas barrier properties in the lamination type barrier film.

As the organic layer, various kinds of layers used as the organic layer in the well-known lamination type barrier film may be used. For example, as the organic layer, a layer which is obtained by using an organic compound as a main component and which is basically formed by crosslinking a monomer and/or an oligomer may be used.

The lamination type barrier film has an organic layer that becomes a base substrate of an inorganic layer, such that the unevenness of the front surface of the supporting substrate or foreign matters and the like adhering to the front surface may be embedded so as to form an adequate deposition surface of the inorganic layer. As a result, an adequate inorganic layer without fractures or cracks may be formed on the entire deposition surface. High gas barrier performance in which the water vapor permeability is 1×10⁻³ g/(m²·day) or less, and the oxygen permeability is 1×10⁻² cc/(m²·day·atm) or less may be obtained.

In a case where the lamination type barrier film has an organic layer that becomes this base substrate, this organic layer functions as the cushion of the inorganic layer. Therefore, in a case where the inorganic layer is impacted from the outside or the like, the damage of the inorganic layer may be prevented by the cushioning effect of the organic layer.

In the lamination type barrier film, the inorganic layer adequately exhibits gas harrier performances, and deterioration of the wavelength conversion layer 201 due to moisture or oxygen may be suitably prevented.

In the lamination type barrier film, as the material for forming the organic layer, various kinds of organic compounds (resins/polymer compounds) may be used.

Particularly, suitable examples thereof include films of a thermoplastic resin such as polyester, acrylic resin, methacrylic resin, a methacrylic acid-maleic acid copolymer, polystyrene, transparent fluororesin, polyimide, fluorinated polyimide, polyamide, polyamide imide, polyether imide, cellulose acylate, polyurethane, polyether ether ketone, polycarbonate, alicyclic polyolefin, polyarylate, polyethersulfone, polysulfone, fluorene ring modified polycarbonate, alicyclic modified polycarbonate, fluorene ring modified polyester, an acryloyl compound, polysiloxane, or other organosilicon compounds. The plurality of these may be used in combination.

Among these, in view of excellent glass transition temperature and excellent strength, an organic layer including a polymer of a cationically polymerizable compound having a radically polymerizable compound and/or an ether group as a functional group is suitable.

Among these, particularly, in addition to the strength, in view of a low refractive index, high transparency, and excellent optical properties, an acrylic resin and a methacrylic resin that has a polymer of a monomer or an oligomer of acrylate and/or methacrylate as a main component and that has a glass transition temperature of 120° C. or more are suitably exemplified as an organic layer. Among these, particularly, acrylic resins and methacrylic resins that have polymers of difunctional or higher functional, particularly, trifunctional or higher functional monomers or oligomers of acrylate and/or methacrylate such as dipropylene glycol di(meth)acrylate (DPGDA), trimethylolpropane eth)acrylate (TMPTA), and dipentaerythritol hexa(meth)acrylate (DPHA), as main components are suitably exemplified. A plurality of these acrylic resins and methacrylic resins may be preferably used.

In a case where the organic layer is formed with such an acrylic resin or methacrylic resin, an inorganic layer may be formed on a base substrate with a firm skeleton, and thus a denser inorganic layer having high gas barrier properties may be formed.

The thickness of the organic layer is preferably 1 to 5 μm.

In a case where the thickness of the organic layer is 1 μm or more, an adequate deposition surface of the inorganic layer may be more suitably obtained, and thus an adequate inorganic layer without fractures, cracks, or the like may be formed on the entire deposition surface.

In a case where the thickness of the organic layer is caused to be 5 μm or less, it is possible to suitably prevent the problems occurring due to a too thick organic layer such as cracks of the organic layer or curling of a lamination type barrier film.

In view of the above, it is more preferable that the thickness of the organic layer is 1 to 3 μm.

In a case where the lamination type barrier film has a plurality of organic layers as base substrate layers, the thicknesses of the organic layers may be identical to or different from each other.

In a case where the lamination type barrier film has a plurality of organic layers, materials for forming the respective organic layers may be identical to or different from each other. However, in view of productivity, it is preferable that all of the organic layers are formed with the same materials.

It is preferable that the organic layer is formed by the well-known method such as a coating method or a flash vapor deposition method.

In order to improve adhesiveness to an inorganic layer that becomes an underlayer of an organic layer, it is preferable that the organic layer contains a silane coupling agent.

An inorganic layer using this organic layer as a base substrate is formed on the organic layer. The inorganic layer is a film using an inorganic compound as a main component and mainly exhibits gas barrier properties in the lamination type barrier film.

As the inorganic layer, various kinds of films that exhibit gas barrier properties and that includes metal oxide, metal nitride, metal carbide, metal carbonitride may be used.

Specifically, a film formed of an inorganic compound, for example, metal oxide such as aluminum oxide, magnesium oxide, tantalum oxide, zirconium oxide, titanium oxide, and indium tin oxide (ITO), metal nitride such as aluminum nitride; metal carbide such as aluminum carbide; silicon oxide such as silicon oxide, silicon oxynitride, silicon oxycarbide, and silicon oxynitride carbide; silicon nitride such as silicon nitride, and silicon nitride carbide; silicon carbide such as silicon carbide; hydride thereof; a mixture of two or more of these; and a hydrogen-containing matter of these is suitably exemplified. According to the present invention, silicon is also considered as metal.

Particularly, in view of exhibiting high transparency and excellent gas barrier properties, a film including a silicon compound such as silicon oxide, silicon nitride, silicon oxynitride, and silicon oxide is suitably exemplified. Among these, particularly, a film including silicon nitride has high transparency, in addition to excellent gas barrier properties and is suitably exemplified.

In a case where the lamination type barrier film has a plurality of inorganic layers, materials for forming the inorganic layers may be identical to or different from each other. However, considering the productivity, it is preferable that all of the inorganic layers are formed of the same material.

With respect to the thickness of the inorganic layer, the thickness capable of exhibiting desired gas barrier properties may be suitably determined according to the forming material. According to the research by the present inventors, the thickness of the inorganic layer is preferably 10 to 200 nm.

In a case where the thickness of the inorganic layer is 10 inn or more, it is possible to form an inorganic layer that stably exhibits sufficient gas barrier performances. The inorganic layer is generally brittle, and in a case where the inorganic layer is too thick, it is likely that fractures, cracks, peeling and the like may occur. However, in a case where the thickness of the inorganic layer is caused to be 200 nm or less, occurrence of the fractures may be prevented.

Considering the above, the thickness of the inorganic layer is preferably 10 to 100 nm and more preferably 15 to 75 nm.

In a case where the lamination type barrier film has a plurality of inorganic layers, the thicknesses of the respective inorganic layers may be identical to or different from each other.

The inorganic layer may be formed by the well-known method according to the forming material. Specifically, plasma CVD such as capacitively coupled plasma (CCP)-chemical vapor deposition (CVD) or inductively coupled plasma (ICP)-CVD, sputtering such as magnetron sputtering or reactive sputtering, and a vapor phase deposition method such as vapor deposition are suitably exemplified.

In the wavelength conversion element 103, it is preferable that an end face is covered with an end face sealing layer including a material exhibiting gas barrier properties. Accordingly, it is possible to prevent infiltration of oxygen from an end face of the wavelength conversion element 103 to the wavelength conversion layer 201.

As the end face sealing layer, various kinds of layers including a material having gas barrier properties for inhibiting passing of oxygen or moisture, such as a metal layer such as a plating layer, an inorganic compound layer such as a silicon oxide layer and/or a silicon nitride layer, and a resin layer including a resin material such as an epoxy resin or a polyvinyl alcohol resin may be used. The end face sealing layer may have a multilayer configuration such as a configuration of including a base substrate metal layer and a plating layer or a configuration including a polyvinyl alcohol layer as an underlayer (tile wavelength conversion element 103 side) and an epoxy resin layer as an upper layer. FIG. 6 conceptually illustrates a configuration in which the end face of the wavelength conversion element 103 is covered with an end face sealing layer 203.

As an example of the end face sealing layer 203, a composition having the following composition can be used. The composition is a part by mass in a case where the solid content as a whole is 100 parts by mass.

| | |
|---|---|
| Main agent of two part-type thermosetting epoxy | 40 parts by mass |
| resin (E-30CL manufactured by Henkel Japan Ltd.) | |
| Curing agent of two part-type thermosetting epoxy | 20 parts by mass |
| resin (E-30CL manufactured by Henkel Japan Ltd.) | |
| 1-butanol | 60 parts by mass |

According to the present invention, without being limited to the specific example of the wavelength conversion element 103 as described above, a wavelength conversion element having a configuration in which the phosphor itself is dispersed in a transparent inorganic material such as glass or a configuration in which a liquid wavelength conversion material is enclosed can be used without limitation.

(Arrangement of Wavelength Conversion Element)

The wavelength conversion element 103 is thermally coupled to the heat radiation element 105. By thermally coupling, heat energy generated in a case where the wavelength conversion element 103 absorbs the excitation light and emits light can be radiated so as to homogenize the in-plane temperature distribution.

According to one aspect, the wavelength conversion element 103 is cut out in the shape illustrated in FIG. 4, and this wavelength conversion element can be bonded to the reflective element in surface contact with the heat radiation element 105 by using a pressure sensitive adhesive (high transparency adhesive transfer tape 8146-2 manufactured by The 3M Company, thickness: 50 μm).

The thickness, the size, and the shape of the wavelength conversion element 103 can be randomly adjusted such that the planar light source becomes white. According to one aspect, as illustrated in the upper left part of FIG. 4, the wavelength conversion element 103 can be arranged in a shape in which an 8 mm square in the center of 40 mm square is repeatedly drawn such that the light emitting surface of the excitation light source 102 emerges from the center.

A required number of wavelength conversion elements 103 can be reduced, as the illuminance of the excitation light is higher. As the wavelength is smaller, a used amount of the expensive wavelength conversion material can be reduced.

(Excitation Light Source)

As the excitation light source 102, various kinds of well-known point light sources may be used, as long as the point light sources apply light having a wavelength that may be converted by the wavelength conversion element 103.

Among these, a light emitting diode (LED) is suitably exemplified. As described above, as the wavelength conversion layer 201 of the wavelength conversion element 103, a quantum dot layer obtained by dispersing a quantum dot in a matrix of a resin or the like is suitably used. Therefore, as the excitation light source 102, a blue LED that applies blue light is particularly and suitably used. Among these, particularly, a blue LED having a peak wavelength of 450 nm±50 nm is suitably used.

The excitation light source 102 included in the planar light source 10 of the embodiment of the present invention is not particularly limited, and may be only a light emitting chip or may be a package including a light emitting chip, a heat radiating body, a lead portion, and a molding portion.

The light emitting chip is formed by using a material such as a GaAlAs-based, AlGaIn-based, AlGainP-hased, AlGaInPAs-based, GaN-based materials, but the present invention is not limited thereto, and the light emitting chip may have various configurations with other semiconductor materials.

In the planar light source 10 of the embodiment of the present invention, the output of the excitation light source 102 is not particularly limited and may be suitably set according to the illuminance (brightness) of light and the like required in the planar light source 10.

The light emitting performances of the excitation light source 102 such as a peak wavelength, a profile of illuminance, and a full width at half maximum are not particularly limited and may be suitably set according to the size of the planar light source 10, the distance between the excitation light source 102 and the wavelength conversion element 103, performances of the wavelength conversion layer 201, and the gap of the excitation light sources 102 in a case of arranging the plurality of excitation light sources 102.

Here, in the planar light source 10 of the embodiment of the present invention, it is preferable that the light applied by the excitation light source 102 has high directivity. Specifically, in the excitation light source 102, a full width at half maximum is preferably 70° or less and more preferably 65° or less.

It is preferable that the illuminance of the light applied by the wavelength conversion element 103 can be increased by causing the full width at half maximum of the excitation light source 102 to be 70° or less, and the contrast in the screen may be caused to be clear by reducing the influence of the adjacent excitation light source 102 during the local dimming (local brightness control) in a case of using the plurality of excitation light sources 102.

According to an aspect, it is possible to use a blue LED (NSPB346KS manufactured by Nichia Corporation, peak wavelength 450 nm, full width at half maximum of 55°) as the excitation light source 102.

According to one aspect, 256 blue LEDs can be arranged on the heat radiation element 105 of an aluminum material having a size of 65 inches so as to have equal longitudinal and lateral intervals.

According to another aspect, two blue LEDs are set as one group, and the two blue LEDs can be arranged adjacent to each other such that 128 sets (256 in total) are arranged to have the equal interval. An arrangement example of the excitation light source 102 is conceptually illustrated in FIG. 7.

(Tint of Planar Light Source)

The planar light source 10 of the embodiment of the present invention is preferably a white light source.

The white light source refers to a light source having color temperatures from 6,000 K to 80,000 K.

In a case where the light source is white, the light source is suitably used for a backlight for a liquid crystal display device. Particularly, the color temperature preferable for display applications is from 7,500 K to 80,000 K.

(Brightness of Planar Light Source)

The maximum brightness of the planar light source 10 is preferably 10,000 cd/m² or more, more preferably 12,000 cd/m² or more, even more preferably 15,000 cd/m² or more, and still even more preferably 18,000 cd/m² or more. By using the planar light source 10 with the high maximum brightness as a backlight, the peak brightness of the display can easily achieve 1,000 nits or more such that a display conforming to the Ultra HD Premium standard defined by the Ultra HD Alliance can be provided. According to the present invention, light leak during black display accompanied by temperature distribution is improved, and thus the planar light source 10 is a backlight preferable for a liquid crystal display device in a high dynamic range. A liquid crystal display device in a higher dynamic range can be realized by improving the combination with the local dimming function to be described later, the light leak amount in the black display state of the panel due to optical compensation, the panel opening ratio, and the like.

(Method of Measuring of Brightness Tint of Planar Light Source)

The tint and the maximum brightness of the planar light source 10 can be measured by using spectral brightness meter (SR-LEDH manufactured by Topcon Technohouse Corporation).

(Thickness of Planar Light Source)

The thickness of the planar light source 10 is preferably thin.

The distance between the light emitting surface of the excitation light source 102 and the emission surface 106 of the planar light source 10 is preferably 20 mm or less, more preferably 15 mm or less, even more preferably 10 mm or less, and particularly preferably 5 mm or less.

By causing the thickness to be thin, in a case where the planar light source 10 of the embodiment of the present invention is used as a baeldight of a liquid crystal display device, the planar light source 10 can be provided as a liquid crystal display device having excellent designability and excellent space-saving properties.

The backlight unit of the embodiment of the present invention is a backlight unit using such a planar light source of the embodiment of the present invention as a light source. Basically, the backlight unit of the embodiment of the present invention may be the same as various well-known backlight units except that the planar light source of the embodiment of the present invention is used.

(Local Dimming of Backlight)

The backlight using the planar light source of the embodiment of the present invention preferably has a local dimming (local brightness controlling) function. By installing the local dimming function, the contrast of the displayed image is enhanced, and thus it is possible to provide a liquid crystal display device with an excellent display quality. As the division number capable of local dimming, 64 divisions, 128 divisions, and 256 divisions are generally used, but the present invention is not limited thereto.

The liquid crystal display device of the embodiment of the present invention is a liquid crystal display device using such a backlight unit of the embodiment of the present invention as a backlight. Basically, the liquid crystal display device of the embodiment of the present invention may be the same as various well-known liquid crystal display devices except that the backlight unit of the embodiment of the present invention is used.

### EXPLANATION OF REFERENCES

10: planar light source
101: reflective element
102: excitation light source
103: wavelength conversion element
104: brightness homogenizing element
104a: spacing portion
105: heat radiation element
106: emission surface
201: wavelength conversion layer
202: supporting film
203: end face sealing layer

What is claimed is:

1. A planar light source comprising:
a heat radiation element;
a reflective element;
at least one excitation light source;
at least one wavelength conversion element; and
a brightness homogenizing element,
wherein the at least one excitation light source has a light emitting surface between the reflective element and an emission surface of the planar light source and emits at least light having a first wavelength,
the wavelength conversion element is positioned between the reflective element and the brightness homogenizing element, is thermally coupled to the heat radiation element, absorbs at least a part of a light having a first wavelength, and emits at least one light having a wavelength different from the light having a first wavelength, and
reflectance of the brightness homogenizing element with respect to light on the excitation light source side has distribution in an in-plane.

2. The planar light source according to claim 1,
wherein the wavelength conversion element includes a quantum dot.

3. The planar light source according to claim 1,
wherein reflectance of the brightness homogenizing element with respect to the light on the excitation light source side is maximum on an optical axis of the excitation light source.

4. The planar light source according to claim 2,
wherein reflectance of the brightness homogenizing element with respect to the light on the excitation light source side is maximum on an optical axis of the excitation light source.

5. The planar light source according to claim 1,
wherein the wavelength conversion element is in contact with the reflective element or is bonded to the reflective element with an adhesive or a pressure sensitive adhesive.

6. The planar light source according to claim 4,
wherein the wavelength conversion element is in contact with the reflective element or is bonded to the reflective element with an adhesive or a pressure sensitive adhesive.

7. A backlight unit obtained by using the planar light source according to claim 1.

8. A backlight unit obtained by using the planar light source according to claim 6.

9. A liquid crystal display device having the backlight unit according to claim 7.

10. A liquid crystal display device having the backlight unit according to claim 9.
